(19) United States
(12) Patent Application Publication
(10) Pub. No.: US 2017/0347676 A1
(43) Pub. Date: Dec. 7, 2017

(54) NON-DAIRY YOGURT PRODUCT PREPARED FROM COCONUT WATER

(71) Applicant: ABZZ SNACKS, LLC, South San Francisco, CA (US)

(72) Inventor: Ngar Hang Bonnie Lau, Daly City, CA (US)

(21) Appl. No.: 15/615,602

(22) Filed: Jun. 6, 2017

Related U.S. Application Data
(60) Provisional application No. 62/346,439, filed on Jun. 6, 2016.

(51) Int. Cl. A23C 11/02; A23L 33/16; A23L 29/00; A23L 19/00; A23L 33/185; A23L 29/20

(52) U.S. Cl. CPC A23C 11/02; A23L 33/185; A23L 29/20; A23L 29/065; A23L 19/00; A23L 33/16; A23V 2002/00

(57) ABSTRACT

Non-dairy yogurt products prepared from coconut water are disclosed. The products can include an excess weight percent coconut water compared to the weight percent coconut milk. The products exhibit good consistency, texture, flavor, and sheen.

This application claims the benefit under 35 U.S.C. §119(e) of U.S. Provisional Application No. 62/346,439 filed on Jun. 6, 2016, which is incorporated by reference in its entirety.

### FIELD

The invention relates to non-dairy yogurt products prepared from coconut water.

### BACKGROUND

Non-dairy food products for people who are lactose intolerant are not appealing to consumers in general because such products lack luster or sheen and/or have an inconsistent texture that has separation of water issues. While there have been attempts to produce non-dairy food products using coconut water, these efforts have led to undesirable products because of undesirable characteristics including non-uniform or lumpy texture, separation of water, lack of sheen or gloss, high fat content or excessive use of added sugar.

### SUMMARY

The present invention satisfies the consumer's desire to have a nutritious, appealing and tasty non-dairy yogurt product that is low-fat, does not have added sugar, and has a similar texture and consistency as other yogurt products.

According to the present invention, non-dairy yogurt products comprise: up to 50 wt % coconut milk; and up to 70 wt % coconut water, herein wt % is based on the total weight of the non-dairy yogurt product.

According to the present invention non-dairy yogurt products are prepared from ingredients, wherein the ingredients comprise: from 15 wt % to 30 wt % coconut milk; from 50 wt % to 70 wt % coconut water; from 1 wt % to 10 wt % inulin; from 1 wt % to 8 wt % starch, wherein the starch comprises corn starch and tapioca starch; a natural sweetener; and a live, active culture and/or probiotic comprising Lactobacillus delbueckii subsp. bulgaricus, Streptococcus salivarius subsp. thermophiles, Lactobacillus acidophilus, and Bifidobacterium ssp., wherein wt % is based on the total weight of the yogurt product.

According to the present invention, methods of making non-dairy yogurt products comprise combining ingredients to form a mixture, wherein the ingredients comprise up to 50 wt % coconut milk, up to 70 wt % coconut water; pasteurizing the mixture; adding a live, active culture, a probiotic, or a combination thereof to the pasteurized mixture; and fermenting the mixture to provide a non-dairy yogurt product.

According to the present invention, methods of making a non-dairy yogurt product, comprise: combining ingredients to form a mixture, wherein the ingredients comprise up to 50 wt % coconut milk, up to 70 wt % coconut water; pasteurizing the mixture; adding a live, active culture, a probiotic, or a combination thereof to the pasteurized mixture; and fermenting the mixture to provide a non-dairy yogurt product.

According to the present invention, non-dairy yogurt products are prepared by methods according to the present invention.

Reference is now made to certain compositions and methods of the present invention. The disclosed compositions and methods are not intended to be limiting of the claims. To the contrary, the claims are intended to cover all alternatives, modifications, and equivalents.

### DETAILED DESCRIPTION

Non-dairy yogurt products provided by the present disclosure can be prepared by combining coconut water, coconut milk, soluble fiber, binder, live and active cultures, and probiotics.

For example, a non-dairy yogurt product can be prepared by combining from 15 wt % to 32 wt % coconut milk with from 55 wt % to 70 wt % coconut water, from 18 wt % to 29 wt % coconut milk with from 58 wt % to 70 wt % coconut water, from 21 wt % to 26 wt % coconut milk with from 61 wt % to 68 wt % coconut water, or from 22 wt % to 25 wt % coconut milk with from 63 wt % to 67 wt % coconut water; in addition to other ingredients, where wt % is based on the total weight of the ingredients used to prepare the non-dairy yogurt product.

A non-dairy yogurt product can comprise, for example, from 15 wt % to 50 wt % coconut milk, such as from 15 wt % to 45 wt %, from 15 wt % to 40 wt %, from 15 wt % to 35 wt %, from 15 wt % to 30 wt %, or from 15 wt % to 25 wt % coconut milk, where wt % is based on the total weight of the ingredients used to prepare the non-dairy yogurt product. A non-dairy yogurt product can comprise up to 50 wt % coconut milk, where wt % is based on the total weight of the non-dairy yogurt product.

A non-dairy yogurt product can be prepared by combining from 25 wt % to 70 wt % coconut water with the other ingredients, such as from 30 wt % to 70 wt %, from 35 wt % to 70 wt %, from 40 wt % to 70 wt %, from 45 wt % to 70 wt %, from 50 wt % to 70 wt %, from 55 wt % to 70 wt %, from 60 wt % to 70 wt %, or from 65 wt % to 70 wt % coconut water with the other ingredients, where wt % is based on the total weight of the ingredients used to prepare the non-dairy yogurt product. A non-dairy yogurt product can comprise up to 70 wt % coconut water.

A non-dairy yogurt product can comprise, for example, from 15 wt % to 50 wt % coconut milk and from 25 wt % to 70 wt % coconut water; from 15 wt % to 45 wt % coconut milk and from 30 wt % to 70 wt % coconut water; from 15 wt % to 40 wt % coconut milk and from 30 wt % to 70 wt % coconut water; from 15 wt % to 45 wt % coconut milk and from 35 wt % to 70 wt % coconut water; from 15 wt % to 40 wt % coconut milk and from 40 wt % to 70 wt % coconut water; from 15 wt % to 35 wt % coconut milk and from 45 wt % to 70 wt % coconut water; or from 15 wt % to 30 wt % coconut milk and from 50 wt % to 70 wt % coconut water, where wt % is based on the total weight of the non-dairy yogurt product. A non-dairy yogurt product can comprise up to 50 wt % coconut milk and up to 70 wt % coconut water, where wt % is based on the total weight of the non-dairy yogurt product.

A non-dairy yogurt product can be prepared by combining coconut water and coconut milk such that the wt % coconut water is greater than the wt % coconut milk. For example, the wt % coconut water can be at least 1.5 times greater than the wt % coconut milk, at least 2 times greater, at least 3 times greater, or at least 4 times greater than the wt % of coconut milk, where wt % is based on the total weight of the ingredients used to prepare the non-dairy yogurt product.

Coconut water refers to the liquid obtained from an immature coconut. Coconut milk is derived from the flesh of a mature coconut. An example of the constituents of natural coconut water and natural coconut milk are compared in Table 1.

TABLE 1
Examples of components of
coconut water and coconut milk

| | Coconut | Coconut |
|---|---|---|
| | Water | Milk |
| Component | (wt %) | (wt %) |
| Carbohydrates | 1-7 | 2.5-8.5 |
| Sugars | 1-4 | 1-6 |
| Fibers | 0.1-2.1 | 1-6 |
| Fats | <2 | 20-28 |
| Protein | 0.1-1.5 | 0.5-4.5 |
| Water | 85-97 | 60-75 |

Although the exact wt % may vary depending, for example, upon the source, it can be appreciated that natural coconut milk has a much higher fat content than does coconut water. For example, coconut milk can have a fat content that is 20 times to 40 times that of coconut water.

The coconut water and the coconut milk used in non-dairy yogurt products can be derived from the natural coconut product and used directly in liquid form, can be reconstituted from a powdered form derived from the natural product, or can be reconstituted from a concentrate derived from the natural product.

Coconut water used to prepare a non-dairy yogurt product can comprise, for example, from 85 wt % to 98 wt % water, from 88 wt % to 97 wt % water, from 91 wt % to 96 wt % water, or from 94 wt % to 96 wt % water, where wt % is based on the total weight of the coconut water.

Coconut milk used to prepare a non-dairy yogurt product can comprise, for example, from 60 wt % to 75 wt % water, from 62 wt % to 73 wt % water, from 64 wt % to 71 wt % water, or from 66 wt % to 70 wt % water, where wt % is based on the total weight of the coconut milk.

In non-dairy yogurt products provided by the present disclosure the coconut water is used as the primary ingredient. Coconut water can be used to manufacture the yogurt product without prior treatment. For example, other non-dairy yogurt products a plant-based milk is the primary ingredient. To prepare a based, water and a plant-based material are combined and homogenized. For example, to prepare an almond-based milk, water and almonds are combined, homogenized and filtered. The plant-based milk is combined with other ingredients to make the yogurt product. In another method of producing a plant-based milk, water is combined with a cream such as coconut cream to form a base having, for example, from about 20 wt % to 25 wt % water, where wt % is based on the total weight of the base. In the present invention, the coconut water is not homogenized and contains a naturally low fat content. In the non-dairy yogurt products provided by the present disclosure, coconut water, and not a coconut base is used as the primary ingredient. The coconut water serves to provide texture, improve taste, facilitate culture growth, and allows for reduced fat content in the product without compromising taste. The high content of coconut water also provides electrolytes to the non-dairy yogurt product. Natural coconut water contains a high concentration of a variety of electrolytes. Non-dairy yogurt products provided by the present disclosure can comprise eight or more electrolyte minerals.

Soluble fiber can be included in a non-dairy yogurt product for fortification, to reduce the calories, to moderate blood glucose levels and/or to lower cholesterol. Soluble fibers include inulin, pectins, gums, mucilages (β-glucan), polydextrose, psyllium, resistant starch, wheat dextrin, and some hemicelluloses. Examples of suitable soluble fibers include soluble fiber derived from chicory and other fructan-containing foods. One or more types of soluble fibers can be used to prepare a non-dairy yogurt product. In certain embodiments, a soluble fiber can be derived from chicory root. Soluble fiber derived from chicory root can include a mixture of non-digestible oligo-and polysaccharides built up of fructose units with β₂₋₁ bond, mostly ending with a glucose unit. From 2 wt % to 10 wt % soluble fiber can be used to prepare a non-dairy yogurt product, such as from 2 wt % to 8 wt %, from 3 wt % to 7 wt %, or from 4 wt % to 6 wt %, where wt % is based on the total weight of the ingredients used to prepare the non-dairy yogurt product.

A binder can be included in a non-dairy yogurt product. A binder can serve to control separation of ingredients and water in a product. Examples of suitable binders include a starch. One or more different binders can be used. In certain embodiments, a binder can include a starch derived from corn. In certain embodiments a binder can include a starch derived from tapioca. In certain embodiments, a binder can be a combination of tapioca starch and corn starch. A non-dairy yogurt product can be prepared by combining, for example, from 1 wt % to 8 wt %, from 2 wt % to 7 wt %, from 3 wt % to 6 wt % or from 4 wt % to 6 wt % of a binder or combination of binders, where wt % is based on the total weight of the ingredients used to prepare the non-dairy yogurt product.

A non-dairy yogurt product can include a live, active culture or a combination of live, active cultures, and/or a probiotic or combination of probiotics. It is desirable to select a live, active culture and probiotic that can interact with the naturally occurring sugars in the coconut water, ferment the product, and have a neutral or clean taste and/or produce cultured flavors that complement the coconut based product. In particular, a live, active culture and/or probiotic must be able to ferment the non-dairy based yogurt product having a low sugar content compared to other yogurt products such as coconut milk-based yogurts, and provide a pleasing taste to a consumer. Suitable live, active culture and/or probiotic cultures can also exhibit a short fermentation time such as less than 6 hours, less than 8 hours, or less than 10 hours, and provide a product that has a slightly sour or tart flavor and a creamy texture. For example, a suitable live and active culture and/or probiotic can comprise strains such as Lactobacillus delbueckii subsp. bulgaricus, Streptococcus salivarius subsp. thermophiles, Lactobacillus acidophilus, Bifidobacterium ssp. or combinations of any of the foregoing.

Ingredients for preparing a non-dairy yogurt product can include from 0.018 wt % to 0.038 wt % of a live and active culture and/or probiotic, from 0.02 wt % to 0.036 wt %, from 0.022 wt % to 0.034 wt %, from 0.024 wt % to 0.032 wt %, or from 0.026 wt % to 0.030 wt %, of a live and active culture and/or probiotic, where wt % is based on the total weight of the ingredients used to prepare the non-dairy yogurt product. A non-dairy yogurt product can comprise, for example, from 0.01 wt % to 0.05 wt % of a live and active culture and/or probiotic, where wt % is based on the total weight of the ingredients used to prepare the non-dairy yogurt product.

A non-dairy yogurt product can include a dietary additive, a protein, a buffering agent, a natural sweetener, an antimicrobial, or a combination of any of the foregoing. A non-dairy yogurt product can include other ingredients such as, for example, calcium, protein, potassium phosphate, a natural sweetener, an antimicrobial, or a combination of any of the foregoing.

Calcium can be included in a non-dairy yogurt product as a dietary additive. Calcium can be provided as a calcium phosphate or a combination of calcium phosphates. Examples of suitable calcium phosphates include tricalcium phosphate Ca₅(PO₄)₃(OH). The ingredients used to prepare a non-dairy yogurt product can include from 0.1 wt % to 0.6 wt % of a calcium phosphate, from 0.15 wt % to 0.5 wt %, or form 0.2 wt % to 0.4 wt % of a calcium phosphate or combination of calcium phosphates, where wt % is based on the total weight of the ingredients used to prepare the non-dairy yogurt product.

A non-dairy yogurt product can include a protein, which can serve to increase the protein content of the non-dairy yogurt product, enrich the amino acid content, bind water and fat, and increase viscosity. Examples of suitable proteins include plant protein such as potato protein, pea protein, rice protein, cranberry protein, defatted pumpkin seed protein, or a combination of any of the foregoing. In certain embodiments, the protein will not be a soy protein, which can be allergenic. It can be desirable that the protein absorb moisture and thereby cause the mixture to thicken. Protein also has an emulsifying function and helps to create a stable product matrix. It can also be desirable that the protein have a clean taste. Potato protein can both absorb moisture and has a clean taste. Ingredients for preparing a non-dairy yogurt product can include from 0 wt % to 15 wt % protein such as from 0.1 wt % to 15 wt % protein. A non-dairy yogurt product may not contain any added protein. In certain embodiments, a yogurt product may contain added protein such as from 1 wt % to 15 wt %, from 1 wt % to 10 wt %, from 1 wt % to 7 wt %, from 2 wt % to 6 wt %, or from 3 wt % to 5 wt %, where wt % is based on the total weight of the ingredients used to prepare the non-dairy yogurt product.

Ingredients used to prepare a non-dairy yogurt product can include a potassium phosphate such as dipotassium phosphate. Potassium phosphate acts as a buffering agent to prevent or to minimize coagulation. A potassium phosphate can prevent or minimize ingredients separating and maintain ingredients dispersed in the mixture. For example, dipotassium phosphate can be used in embodiments containing a protein to homogeneously disperse the protein in the mixture. The ingredients can include, for example, from 0.01 wt % to 0.09 wt %, form 0.02 wt % to 0.08 wt %, from 0.03 wt % to 0.07 wt %, or from 0.04 wt % to 0.06 wt % of a potassium phosphate such as dipotassium phosphate.

Ingredients used to prepare a non-dairy yogurt product can include a sweetener such as a natural sweetener. Examples of suitable natural sweeteners include a mogroside, stevia, erythritol, xylitol, yacon syrup, and combinations of any of the foregoing. A natural sweetener can be extracted , for example, from a fruit. In certain embodiments, a natural sweetener can be a mogroside such as mogroside V, which can be extracted from monk fruit. Examples of suitable sweeteners include monk fruit extract, Stevia, and allulose. A natural sweetener can have a low glycemic index and promote growth of yogurt cultures. The ingredients used to prepare a non-dairy yogurt product can include from 0.0005 wt % to 0.004 wt % of a natural sweetener, from 0.001 wt % to 0.003 wt %, or from 0.0005 wt % to 0.002 wt % of a natural sweetener.

Ingredients used to prepare a non-dairy yogurt product can include an antimicrobial. An antimicrobial can be added to delay spoilage. It can be desirable that a non-dairy yogurt product exhibit a shelf life of at least 35 days, at least 40 days, at least 45 days, or at least 50 days.

A non-dairy yogurt product can include one or more optional ingredients including, for example, vitamins, flavorings, colorings, cereals, probiotics that do not interact with the yogurt product, or combinations of any of the foregoing. It is desirable that any additive be derived from natural sources.

A non-dairy yogurt product provided by the present disclosure can be characterized, for example, by a total solids content, for example, from 15 wt % to 65 wt %, from 15 wt % to 50 wt %, from 15 wt % to 40 wt %, from 15 wt % to 30 wt %, from 16 wt % to 25 wt %, or from 18 wt % to 20 wt %., where wt % is based on the total weight of the non-dairy yogurt product. The solids content of non-dairy yogurt will increase with increased levels of fortification. With higher the solids content the non-dairy yogurt product will have a richer texture.

A non-dairy yogurt product provided by the present disclosure can be characterized, got example, by a total fat content from 2 wt % to 10 wt %, from 2 wt % to 8 wt %, from 2 wt % to 6 wt %, or from 3 wt % to 5 wt % total fat, where wt % is based on the total weight of the non-dairy yogurt product. A non-dairy yogurt product provided by the present disclosure can have less than 2 wt % total fat, less than 4 wt % total fat, less than 6 wt % total fat, less than 8% total fat, or less than 10% total fat, where wt % is based on the total weight of the non-dairy yogurt product.

A non-dairy yogurt product provided by the present disclosure can be prepared from ingredients including from 20 wt % to 28 wt % coconut milk; from 60 wt % to 75 wt % coconut water; from 4 wt % to 8 wt % soluble fiber; from 3 wt % to 6 wt % starch, and from 0 wt % to 10 wt % plant protein, where wt % is based on the total weight of the ingredients.

A non-dairy yogurt product provided by the present disclosure can be prepared from ingredients including from 22 wt % to 26 wt % coconut milk; from 63 wt % to 72 wt % coconut water; from 5 wt % to 7 wt % soluble fiber; from 2 wt % to 5 wt % starch, and from 0 wt % to 10 wt % plant protein, where wt % is based on the total weight of the ingredients.

A non-dairy yogurt product can comprise: from 15 wt % to 30 wt % of coconut milk; from 50 wt % to 70 wt % of coconut water; from 2 wt % to 10 wt % of a soluble fiber; and from 1 wt % to 8 wt % of a starch, wherein wt % is based on the total weight of the non-dairy yogurt product.

A non-dairy yogurt product provided by the present disclosure can be prepared from ingredients including from 20 wt % to 28 wt % coconut milk; from 60 wt % to 75 wt % coconut water; from 4 wt % to 8 wt % inulin; from 3 wt % to 6 wt % starch, where the starch comprises corn starch and tapioca starch; and a natural sweetener; a live, active culture and/or probiotic culture comprising Lactobacillus delbueckii subsp. bulgaricus, Streptococcus salivarius subsp. thermophiles, Lactobacillus acidophilus, and Bifidobacterium ssp.,where wt % is based on the total weight of the ingredients. In addition to the ingredients above, a non-dairy yogurt product provided by the present disclosure can include from 2 wt % to 5 wt % potato protein, and from 0.4 wt % to 0.6 wt % dipotassium phosphate, where wt % is based on the total weight of the ingredients.

A non-dairy yogurt product provided by the present disclosure can be prepared from ingredients including from 22 wt % to 26 wt % coconut milk; from 63 wt % to 72 wt % coconut water; from 5 wt % to 7 wt % inulin; from 4 wt % to 5 wt % starch, where the starch comprises corn starch and tapioca starch; and a natural sweetener; a live, active culture and/or probiotic culture comprising Lactobacillus delbueckii subsp. bulgaricus, Streptococcus salivarius subsp. thermophiles, Lactobacillus acidophilus, and Bifidobacterium ssp., where wt % is based on the total weight of the ingredients. In addition to the ingredients above, a non-dairy yogurt product provided by the present disclosure can include from 3 wt % to 4 wt % potato protein, and from 0.3 wt % to 0.5 wt % dipotassium phosphate, where wt % is based on the total weight of the ingredients.

A non-diary yogurt product can include a cereal or grain such as oats or granola. The cereal or grain can be maintained in a separate package or container that can be conveniently mixed with the non-dairy yogurt before use. The cereal or grain can be mixed into the non-dairy yogurt product.

A non-dairy yogurt product can include a fruit, berry or other flavored ingredient that can be mixed with the non-dairy yogurt before use. Examples of suitable fruits and berries include strawberry, raspberry, blueberry, black raspberry, blackberry, gooseberry, cranberry, loganberry, apricot, cherry, black cherry, mango passion fruit, peach, pineapple, pomegranate, watermelon, and guava. Cereal or grain can be mixed in with the non-dairy yogurt or can be maintained in a separate package or container that can be conveniently mixed with the non-dairy yogurt before use.

A non-dairy yogurt can include, for example, a flavoring such as vanilla, vanilla bean, banana, chocolate, butter-scotch, orange, peanut butter, strawberry, raspberry, blueberry, black raspberry, blackberry, gooseberry, cranberry, loganberry, apricot, cherry, black cherry, mango passion fruit, peach, pineapple, pomegranate, watermelon, guava, coconut, coffee, lime, lemon, or other flavoring. A flavoring can be combined and blended with the non-dairy yogurt.

Non-dairy yogurt products provided by the present disclosure are substantially free of milk-based products and/or derivatives, and are made with carbohydrates derived from natural sources. In certain embodiments, non-dairy yogurt products provided by the present disclosure are substantially free of milk proteins and/or derivatives of milk proteins such as casein, whey, and caseinates. In certain embodiments, a non-dairy yogurt product provided by the present disclosure is free of animal ingredients and animal-derived ingredients and can be classified as a vegan product.

Non-dairy yogurt products are characterized by a taste, viscosity, sheen, and low separation that is acceptable to a consumer, and that is similar to or superior to that of dairy-based yogurt products.

A non-dairy yogurt product provided by the present disclosure can be characterized by a viscosity from 80,000 mPa/sec to 150,000 mPa/sec, such as from 80,000 mPa/sec to 125,000 mPa/sec. Viscosity can be determined using a Brookfield viscometer.

In certain embodiments, the process of making the non-dairy yogurt may constitute using a liquefier or a silo to mix the liquid ingredients. The liquid can then be raised to a high temperature for a short time of around 10 seconds to 30 seconds. The liquid can then be put in a holding tube for 10 minutes to 15 minutes to cool. The mixture can then be pasteurized. The cooling section can be kept at 40° F. (4° C.). The live, active culture and/or probiotic can then be added with gentle agitation to ferment the liquid. After fermenting for less than 9 hours, the liquid can attain a pH of 4.2 to 4.6. The mixture can then be broken by stirring and cooling to 40° F. (4° C.) and then filled in packaging cups per serving size.

In certain embodiments, the process of making a non-dairy yogurt product may constitute the following steps. Coconut milk can be conditioned in a container of hot water for 30 minutes. All ingredients can be weighed and then added into a cooking pot. One could start with the wet ingredients followed by the dry ingredients. A mixer can be used to mix and combine the ingredients. One can stop mixing as soon as content is well mixed and avoid generating excessive foam. The mixture can be pasteurized. The pot can then be cooled to 112° F. (44° C.). The live, active culture and/or probiotic can be added into a warm pasteurized mixture and stirred until incorporated. The mixture can be covered to prevent moisture loss and contamination. The mixture can be incubated at an appropriate temperature for less than 9 hours. The fermented product can be stirred and chilled in a water bath for 10 minutes to 15 minutes to stop fermentation. Any flavor(s) can be added at this stage and stirred until well mixed. The mixture can be transferred and poured into packaging cups. The product can then be refrigerated.

### Aspects of the Invention

Aspect 1. A non-dairy yogurt product prepared from ingredients, wherein the ingredients comprise from 15 wt % to 40 wt % coconut milk; and from 25 wt % to 70 wt % coconut water, wherein wt % is based on the total weight of the ingredients.

Aspect 2. The non-dairy yogurt product of aspect 1, wherein the ingredients comprise soluble fiber; a starch; and probiotic cultures.

Aspect 3. The non-dairy yogurt product of any one of aspects 1 to 2, wherein the ingredients comprise from 20 wt % to 28 wt % of the coconut milk; from 60 wt % to 70 wt % of the coconut water; from 4 wt % to 8 wt % of the soluble fiber; and from 3 wt % to 6 wt % of the starch, wherein wt % is based on the total weight of the ingredients.

Aspect 4. The non-dairy yogurt product of aspect 3, wherein the soluble fiber comprises inulin.

Aspect 5. The non-dairy yogurt product of any one of aspects 3 to 4, wherein the starch comprises corn starch, tapioca starch, or a combination thereof.

Aspect 6. The non-dairy yogurt product of any one of aspects 1 to 5, wherein the ingredients comprise from 0 wt % to 10 wt % plant protein, wherein wt % is based on the total weight of the ingredients.

Aspect 7. The non-dairy yogurt product of aspect 6, wherein plant protein comprises potato protein.

Aspect 8. The non-dairy yogurt product of any one of aspects 1 to 7, wherein the ingredients comprise a natural sweetener.

Aspect 9. The non-dairy yogurt product of aspect 8, wherein the natural sweetener comprises a mogroside.

Aspect 10. The non-dairy yogurt product of any one of aspects 1 to 9, wherein the ingredients comprise a probiotic culture.

Aspect 11. The non-dairy yogurt product of aspect 10, wherein the probiotic culture comprises Lactobacillus delbueckii subsp. bulgaricus, Streptococcus salivarius subsp. thermophiles, Lactobacillus acidophilus, and Bifidobacterium ssp.

Aspect 12. The non-dairy yogurt product of any one of aspects 1 to 11, wherein the ingredients comprise a natural antimicrobial.

Aspect 13. The non-dairy yogurt product of any one of aspects 1 to 12, comprising a flavoring.

Aspect 14. The non-dairy yogurt product of any one of aspects 1 to 13, comprising a cereal.

Aspect 15. The non-dairy yogurt product of any one of aspects 1 to 14, wherein the non-dairy yogurt product is characterized by: a solids content from 17 wt % to 65 wt %; and a total fat content from 2 wt % to 10 wt %, wherein wt % is based on the total weight of the ingredients.

Aspect 16. A non-dairy yogurt product prepared from ingredients, wherein the ingredients comprise from 20 wt % to 28 wt % coconut milk; from 60 wt % to 70 wt % coconut water; from 4 wt % to 8 wt % inulin; from 3 wt % to 6 wt % starch, wherein the starch comprises corn starch and tapioca starch; a natural sweetener; and a probiotic culture comprising Lactobacillus delbueckii subsp. bulgaricus, Streptococcus salivarius subsp. thermophiles, Lactobacillus acidophilus, and Bifidobacterium ssp., wherein wt % is based on the total weight of the ingredients.

Aspect 17. The non-dairy yogurt product of aspect 16, wherein the ingredients comprise from 2 wt % to 5 wt % potato protein, wherein wt % is based on the total weight of the ingredients.

Aspect 18. The non-dairy yogurt product of any one of aspects 16 to 17, wherein the ingredients comprise from 0.4 wt % to 0.6 wt % dipotassium phosphate, wherein wt % is based on the total weight of the ingredients.

Aspect 19. A non-dairy yogurt product comprising: up to 50 wt % coconut milk; and up to 70 wt % coconut water, herein wt % is based on the total weight of the non-dairy yogurt product.

Aspect 20. The non-diary yogurt product of aspect 19, wherein the non-dairy yogurt product comprises: from 15 wt % to 50 wt % coconut milk; and from 25 wt % to 70 wt % coconut water.

Aspect 21. The non-dairy yogurt product of any one of aspects 19 to 20, wherein the non-dairy yogurt product comprises soluble fiber; starch; live, active cultures, a probiotic, or a combination of any of the foregoing.

Aspect 22. The non-dairy yogurt product of any one of aspects 19 to 21, wherein the ingredients comprise: from 15 wt % to 30 wt % of the coconut milk; from 50 wt % to 70 wt % of the coconut water; from 2 wt % to 10 wt % of a soluble fiber; and from 1 wt % to 8 wt % of a starch, wherein wt % is based on the total weight of the non-dairy yogurt product.

Aspect 23. The non-dairy yogurt product of aspect 22, wherein, the soluble fiber is derived from chicory; and the starch comprises corn starch, tapioca starch or a combination thereof.

Aspect 24. The non-diary yogurt product of any one of aspects 19 to 23, wherein the non-dairy yogurt product comprises a soluble fiber; a binder; a live and active culture; a probiotic; a protein; a dietary supplement; a buffering agent; a natural sweetener; or a combination of any of the foregoing.

Aspect 25. The non-diary yogurt product of aspect 24, wherein, the soluble fiber is derived from chicory; the starch comprises corn starch, tapioca starch, or a combination thereof; the live and active culture and/or probiotic comprises Lactobacillus delbueckii subsp. bulgaricus, Streptococcus salivarius subsp. thermophiles, Lactobacillus acidophilus, Bifidobacterium ssp., or a combination of any of the foregoing; the protein comprises a plant protein; the dietary supplement comprises calcium phosphate; the buffering agent comprises potassium phosphate; and the natural sweetener comprises mogroside.

Aspect 26. The non-dairy yogurt product of any one of aspects 24 to 25, wherein plant protein comprises potato protein.

Aspect 27. The non-diary yogurt product of any one of aspects 24 to 26, wherein the non-dairy yogurt product comprises: from 1 wt % to 8 wt % of the binder; from 0.018 wt % to 0.038 wt % of the live, active culture and/or probiotic: from 0.1 wt % to 15 wt % of the protein; from 0.1 wt % to 0.6 wt % of the dietary supplement; from 0.01 wt % to 0.09 wt % of the buffering agent; and from 0.0005 wt % to 0.004 wt % of the natural sweetener.

Aspect 28. The non-diary yogurt product of any one of aspects 19 to 27, wherein the non-dairy yogurt product has viscosity within a range from 80,000 mPa/sec to 150,000 mPa/sec, determined using a Brookfield viscometer.

Aspect 29. The non-dairy yogurt product of any one of aspects 19 to 28, wherein the ingredients comprise a natural antimicrobial.

Aspect 30. The non-dairy yogurt product of any one of aspects 19 to 29, comprising a flavoring.

Aspect 31. The non-dairy yogurt product of any one of aspects 19 to 30, comprising a cereal.

Aspect 32. The non-dairy yogurt product of any one of aspects 19 to 31, wherein the non-dairy yogurt product is characterized by: a solids content from 17 wt % to 65 wt %; and a total fat content from 2 wt % to 10 wt %, wherein wt % is based on the total weight of the non-dairy yogurt product.

Aspect 33. A non-dairy yogurt product prepared from ingredients, wherein the ingredients comprise: from 15 wt % to 30 wt % coconut milk; from 50 wt % to 70 wt % coconut water; from 1 wt % to 10 wt % inulin; from 1 wt % to 8 wt % starch, wherein the starch comprises corn starch and tapioca starch; a natural sweetener; and a live, active culture and/or probiotic comprising Lactobacillus delbueckii subsp. bulgaricus, Streptococcus salivarius subsp. thermophiles, Lactobacillus acidophilus, and Bifidobacterium ssp., wherein wt % is based on the total weight of the yogurt product.

Aspect 34. The non-dairy yogurt product of aspect 33, wherein the ingredients comprise from 0.1 wt % to 15 wt % potato protein, wherein wt % is based on the total weight of the yogurt product.

Aspect 35. The non-dairy yogurt product of any one of aspects 33 to 34, wherein the ingredients comprise from 0.01 wt % to 0.09 wt % dipotassium phosphate, wherein wt % is based on the total weight of the yogurt product.

Aspect 36. A method of making the non-dairy yogurt product of any one of aspects 1 to 35, comprising combining ingredients to form a mixture, wherein the ingredients comprise up to 50 wt % coconut milk, up to 70 wt % coconut water; pasteurizing the mixture; adding a live, active culture, a probiotic, or a combination thereof to the pasteurized mixture; and fermenting the mixture to provide a non-dairy yogurt product.

Aspect 37. The method of aspect 36, wherein fermenting is for less than 9 hours.

Aspect 38. The method of any one of aspects 36 to 37, wherein the ingredients comprise: from 15 wt % to 50 wt % coconut milk; and from 25 wt % to 70 wt % coconut water.

Aspect 39. A method of making a non-dairy yogurt product, comprising: combining ingredients to form a mixture, wherein the ingredients comprise up to 50 wt % coconut milk, up to 70 wt % coconut water; pasteurizing the mixture; adding a live, active culture, a probiotic, or a combination thereof to the pasteurized mixture; and fermenting the mixture to provide a non-dairy yogurt product.

Aspect 40. The method of aspect 39, wherein fermenting is for less than 9 hours.

Aspect 41. The method of any one of aspects 39 to 40, wherein the ingredients comprise: from 15 wt % to 50 wt % coconut milk; and from 25 wt % to 70 wt % coconut water.

Aspect 42. A non-dairy yogurt product prepared by the method of any one of aspects 39 to 41.

Finally, it should be noted that there are alternative ways of implementing the embodiments disclosed herein. Accordingly, the present embodiments are to be considered as illustrative and not restrictive. Furthermore, the claims are not to be limited to the details given herein, and are entitled their full scope and equivalents thereof.

1. A non-dairy yogurt product comprising:
up to 50 wt % coconut milk; and
up to 70 wt % coconut water,
wherein wt % is based on the total weight of the non-dairy yogurt product.

2. The non-diary yogurt product of claim 1, wherein the non-dairy yogurt product comprises:
from 15 wt % to 50 wt % coconut milk; and
from 25 wt % to 70 wt % coconut water.

3. The non-dairy yogurt product of claim 1, wherein the non-dairy yogurt product comprises soluble fiber; starch; live, active cultures, a probiotic, or a combination of any of the foregoing.

4. The non-dairy yogurt product of claim 1, wherein the ingredients comprise:
from 15 wt % to 30 wt % of the coconut milk;
from 50 wt % to 70 wt % of the coconut water;
from 2 wt % to 10 wt % of a soluble fiber; and
from 1 wt % to 8 wt % of a starch,
wherein wt % is based on the total weight of the non-dairy yogurt product.

5. The non-dairy yogurt product of claim 4, wherein,
the soluble fiber is derived from chicory; and
the starch comprises corn starch, tapioca starch or a combination thereof.

6. The non-diary yogurt product of claim 1, wherein the non-dairy yogurt product comprises a soluble fiber; a binder; a live and active culture; a probiotic; a protein; a dietary supplement; a buffering agent; a natural sweetener; or a combination of any of the foregoing.

7. The non-diary yogurt product of claim 6, wherein,
the soluble fiber is derived from chicory;
the starch comprises corn starch, tapioca starch, or a combination thereof;
the live and active culture and/or probiotic comprises Lactobacillus delbueckii subsp. bulgaricus, Streptococcus salivarius subsp. thermophiles, Lactobacillus acidophilus, Bifidobacterium ssp., or a combination of any of the foregoing;
the protein comprises a plant protein;
the dietary supplement comprises calcium phosphate;
the buffering agent comprises potassium phosphate; and
the natural sweetener comprises mogroside.

8. The non-dairy yogurt product of claim 7, wherein plant protein comprises potato protein.

9. The non-diary yogurt product of claim 6, wherein the non-dairy yogurt product comprises:
from 1 wt % to 8 wt % of the binder;
from 0.018 wt % to 0.038 wt % of the live, active culture and/or probiotic:
from 0.1 wt % to 15 wt % of the protein;
from 0.1 wt % to 0.6 wt % of the dietary supplement;
from 0.01 wt % to 0.09 wt % of the buffering agent; and
from 0.0005 wt % to 0.004 wt % of the natural sweetener.

10. The non-diary yogurt product of claim 1, wherein the non-dairy yogurt product has viscosity within a range from 80,000 mPa/sec to 150,000 mPa/sec, determined using a Brookfield viscometer.

11. The non-dairy yogurt product of claim 1, wherein the ingredients comprise a natural antimicrobial.

12. The non-dairy yogurt product of claim 1, comprising a flavoring.

13. The non-dairy yogurt product of claim 1, comprising a cereal.

14. The non-dairy yogurt product of claim 1, wherein the non-dairy yogurt product is characterized by:
a solids content from 17 wt % to 65 wt %; and
a total fat content from 2 wt % to 10 wt %,
wherein wt % is based on the total weight of the non-dairy yogurt product.

15. A non-dairy yogurt product prepared from ingredients, wherein the ingredients comprise:
from 15 wt % to 30 wt % coconut milk;
from 50 wt % to 70 wt % coconut water;
from 1 wt % to 10 wt % inulin;
from 1 wt % to 8 wt % starch, wherein the starch comprises corn starch and tapioca starch;
a natural sweetener; and
a live, active culture and/or probiotic comprising Lactobacillus delbueckii subsp. bulgaricus, Streptococcus salivarius subsp. thermophiles, Lactobacillus acidophilus, and Bifidobacterium ssp., wherein wt % is based on the total weight of the yogurt product.

16. The non-dairy yogurt product of claim 15, wherein the ingredients comprise from 0.1 wt % to 15 wt % potato protein, wherein wt % is based on the total weight of the yogurt product.

17. The non-dairy yogurt product of claim 15, wherein the ingredients comprise from 0.01 wt % to 0.09 wt % dipotassium phosphate, wherein wt % is based on the total weight of the yogurt product.

18. A method of making the non-dairy yogurt product of claim 1, comprising
combining ingredients to form a mixture, wherein the ingredients comprise up to 50 wt % coconut milk, up to 70 wt % coconut water;
pasteurizing the mixture;
adding a live, active culture, a probiotic, or a combination thereof to the pasteurized mixture; and
fermenting the mixture to provide a non-dairy yogurt product.

19. The method of claim 18, wherein fermenting is for less than 9 hours.

20. The method of claim 18, wherein the ingredients comprise:
from 15 wt % to 50 wt % coconut milk; and
from 25 wt % to 70 wt % coconut water.

21-24. (canceled)
